(19) United States
(12) Patent Application Publication
(10) Pub. No.: US 2017/0248214 A1
(43) Pub. Date: Aug. 31, 2017

(54) PLANETARY POWERTRAIN CONFIGURATIONS WITH A BALL VARIATOR CONTINUOUSLY VARIABLE TRANSMISSION USED AS A POWERSPLIT

(71) Applicant: Dana Limited, Maumee, OH (US)

(72) Inventors: Gordon M. McIndoe, Volente, TX (US); Travis J. Miller, Cedar Park, TX (US); Sebastian J. Peters, Cedar Park, TX (US)

(21) Appl. No.: 15/445,330

(22) Filed: Feb. 28, 2017

Related U.S. Application Data
(60) Provisional application No. 62/301,248, filed on Feb. 29, 2016.
(60) Provisional application No. 62/356,309, filed on Jun. 29, 2016.

(51) Int. Cl. F16H 37/08; F16H 15/50; F16H 3/66

(52) U.S. Cl. CPC F16H 37/086; F16H 3/66; F16H 15/503; F16H 2200/2064; F16H 2200/2094; F16H 2200/2007; F16H 2200/201

(57) ABSTRACT

Devices and methods are provided herein for the transmission of power in motor vehicles. Power is transmitted in a smoother and more efficient manner by splitting torque into two or more torque paths. A continuously variable transmission is provided with a ball variator assembly having two arrays of balls, a planetary gear set coupled thereto and an arrangement of rotatable shafts with multiple gears and clutches that extend the ratio range of the variator. In some embodiments, clutches are coupled to the gear sets to enable synchronous shifting of gear modes.

### BACKGROUND

A driveline including a continuously variable transmission allows an operator or a control system to vary a drive ratio in a stepless manner, permitting a power source to operate at its most advantageous rotational speed.

### SUMMARY

Provided herein is a continuously variable transmission comprising: a first rotatable shaft operably coupleable to a source of rotational power; a second rotatable shaft aligned substantially coaxial to the first rotatable shaft, the first rotatable shaft and second rotatable shaft forming a main axis of the transmission; a third rotatable shaft aligned substantially parallel to the main axis; a variator assembly having a first traction ring assembly and a second traction ring assembly in contact with a first plurality of balls, each ball having a tillable axis of rotation; wherein the variator assembly is coaxial with the main axis, the first traction ring assembly is coupled to the second rotatable shaft; a first planetary gear set having a first sun gear, a first planet carrier, and a first ring gear; a second planetary gear set arranged coaxial with the main axis, the second planetary gear set having a second sun gear, a second planet carrier, and a second ring gear; wherein the second planet carrier is operably coupled to the first ring gear; wherein the first sun gear is coupled to the first rotatable shaft, and the first planet carrier is operably coupled to the second ring gear; a third planetary gear set arranged coaxial with the third rotatable shaft, the third planetary gear set having a third sun gear, a third planet carrier, and a third ring gear; wherein the third planet carrier is grounded; a forward clutch positioned coaxial with the third rotatable shaft, the forward clutch operably coupled to the third sun gear; and a reverse clutch operably coupled to the forward clutch and the third sun gear.

Provided herein is a vehicle driveline comprising: a power source, a variable transmission of the types disclosed herein drivingly engaged with the power source, and a vehicle output drivingly engaged with the variable transmission. In some embodiments of the vehicle driveline, the power source is drivingly engaged with the vehicle output.

Provided herein is a vehicle comprising the variable transmission of any one of the embodiments disclosed herein.

Provided herein is a method comprising providing a variable transmission of any one of the embodiments disclosed herein.

Provided herein is a method comprising providing a vehicle driveline having any one of the embodiments disclosed herein.

Provided herein is a method comprising providing a vehicle of any embodiment disclosed herein. In some embodiments, the method includes engaging the reverse clutch to operate in a reverse mode. In some embodiments, the method includes engaging the forward clutch to operate in a forward mode. In some embodiments, the method includes engaging the forward clutch and the reverse clutch to operate in a park mode. In some embodiments, the method includes disengaging the forward clutch and the reverse clutch to operate in a neutral mode.

Provided herein is a continuously variable transmission comprising: a first rotatable shaft operably coupleable to a source of rotational power; a second rotatable shaft aligned substantially coaxial to the first rotatable shaft, the first rotatable shaft and second rotatable shaft forming a main axis of the transmission; a variator assembly having a first traction ring assembly and a second traction ring assembly in contact with a first plurality of balls, each ball having a tiltable axis of rotation; wherein the variator assembly is coaxial with the main axis; a first planetary gear set having a first sun gear, a first planet carrier, and a first ring gear; a second planetary gear set arranged coaxial with the main axis, the second planetary gear set having a second sun gear, a second planet carrier, and a second ring gear; wherein the first planetary gear set is coupled to the second planetary gear set; and wherein the variator assembly is coupled to the first planetary gear set and the second planetary gear set.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the preferred embodiments are set forth with particularity in the appended claims. A better understanding of the features and advantages of the present embodiments will be obtained by reference to the following detailed description that sets forth illustrative embodiments, in which the principles of the preferred embodiments are utilized, and the accompanying drawings of which:

FIG. 1 is a side sectional view of a ball-type variator.

FIG. 2 is a plan view of a carrier member that is used in the variator of FIG. 1.

FIG. 3 is an illustrative view of different tilt positions of the ball-type variator of FIG. 1.

FIG. 4 is a schematic diagram of a planetary powersplit continuously variable transmission.

FIG. 5 is a table depicting operating modes of the continuously variable transmission depicted in FIG. 4.

FIG. 6 is a table depicting a number of configurations of continuously variable transmissions having the ball-type variator of FIG. 1 and two planetary gear sets.

FIG. 7 is a schematic diagram of a planetary powersplit continuously variable transmission having two variators.

FIG. 8 is a table depicting operating mode of the continuously variable transmission depicted in FIG. 7.

FIG. 9 is a schematic diagram of a powersplit continuously variable transmission having a rear wheel drive configuration.

### DETAILED DESCRIPTION

The preferred embodiments will now be described with reference to the accompanying figures, wherein like numerals refer to like elements throughout. The terminology used in the descriptions below is not to be interpreted in any limited or restrictive manner simply because it is used in conjunction with detailed descriptions of certain specific embodiments. Furthermore, embodiments includes several novel features, no single one of which is solely responsible for its desirable attributes or which is essential to practicing the embodiments described.

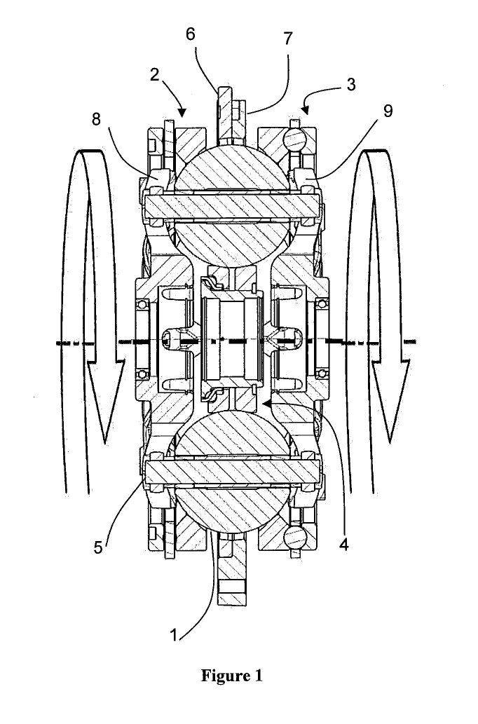

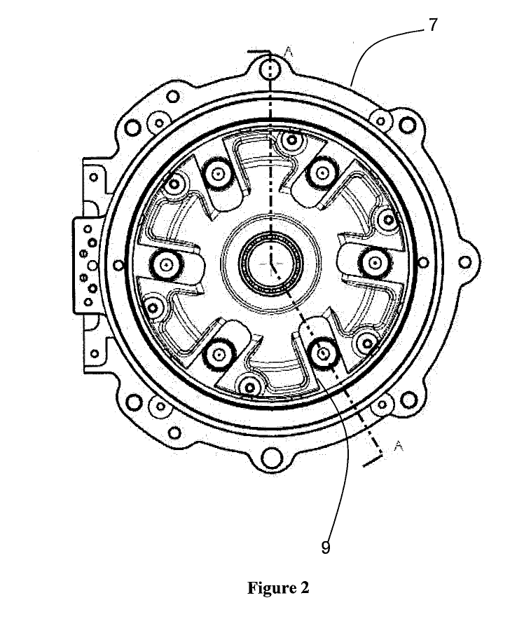

Provided herein are configurations of CVTs based on a ball type variators, also known as CVP, for continuously variable planetary. Basic concepts of a ball type Continuously Variable Transmissions are described in U.S. Pat. Nos. 8,469,856 and 8,870,711 incorporated herein by reference in their entirety. Such a CVT, adapted herein as described throughout this specification, comprises a number of balls (planets, spheres) 1, depending on the application, two ring (disc) assemblies with a conical surface in contact with the balls, an input traction ring 2, an output traction ring 3, and an idler (sun) assembly 4 as shown on FIG. 1. The balls are mounted on tiltable axles 5, themselves held in a carrier (stator, cage) assembly having a first carrier member 6 operably coupled to a second carrier member 7. The first carrier member 6 rotates with respect to the second carrier member 7, and vice versa. In some embodiments, the first carrier member 6 is substantially fixed from rotation while the second carrier member 7 is configured to rotate with respect to the first carrier member, and vice versa. In some embodiments, the first carrier member 6 is provided with a number of radial guide slots 8. The second carrier member 7 is provided with a number of radially offset guide slots 9, as illustrated in FIG. 2. The radial guide slots 8 and the radially offset guide slots 9 are adapted to guide the tiltable axles 5. The axles 5 are adjusted to achieve a desired ratio of input speed to output speed during operation of the CVT. In some embodiments, adjustment of the axles 5 involves control of the position of the first and second carrier members to impart a tilting of the axles 5 and thereby adjusts the speed ratio of the variator. Other types of ball CVTs also exist, but are slightly different.

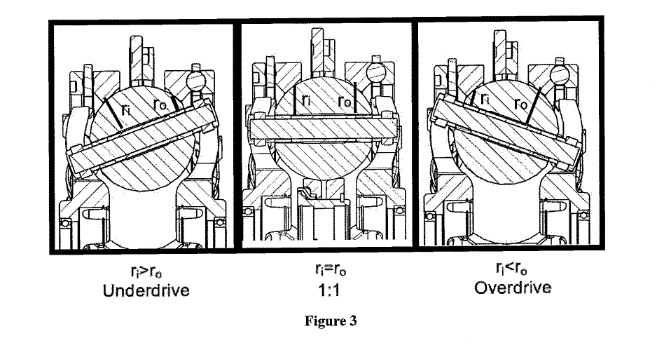

The working principle of such a CVP of FIG. 1 is shown on FIG. 3. The CVP itself works with a traction fluid. The lubricant between the ball and the conical rings acts as a solid at high pressure, transferring the power from the input ring, through the balls, to the output ring. By tilting the balls' axes, the ratio is changed between input and output. When the axis is horizontal the ratio is one, illustrated in FIG. 3, when the axis is tilted the distance between the axis and the contact point change, modifying the overall ratio. All the balls' axes are tilted at the same time with a mechanism included in the carrier and/or idler. Embodiments disclosed here are related to the control of a variator and/or a CVT using generally spherical planets each having a tiltable axis of rotation that are adjusted to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In some embodiments, a control system coordinates the use of a skew angle to generate forces between certain contacting components in the variator that will tilt the planet axis of rotation. The tilting of the planet axis of rotation adjusts the speed ratio of the variator.

For description purposes, the term “radial” is used here to indicate a direction or position that is perpendicular relative to a longitudinal axis of a transmission or variator. The term “axial” as used here refers to a direction or position along an axis that is parallel to a main or longitudinal axis of a transmission or variator. For clarity and conciseness, at times similar components labeled similarly (for example, bearing 1011A and bearing 1011B) will be referred to collectively by a single label (for example, bearing 1011).

As used here, the terms “operationally connected,” “operationally coupled”, “operationally linked”, “operably connected”, “operably coupled”, “operably linked,” “operably coupleable” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling take a variety of forms, which in certain instances will be readily apparent to a person of ordinary skill in the relevant technology.

It should be noted that reference herein to “traction” does not exclude applications where the dominant or exclusive mode of power transfer is through “friction.” Without attempting to establish a categorical difference between traction and friction drives here, generally these are typically understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction force which would be available at the interfaces of the contacting components and is the ratio of the maximum available drive torque per contact force. Typically, friction drives generally relate to transferring power between two elements by frictional forces between the elements. For the purposes of this disclosure, it should be understood that the CVTs described here operate in both tractive and frictional applications. For example, in the embodiment where a CVT is used for a bicycle application, the CVT operates at times as a friction drive and at other times as a traction drive, depending on the torque and speed conditions present during operation.

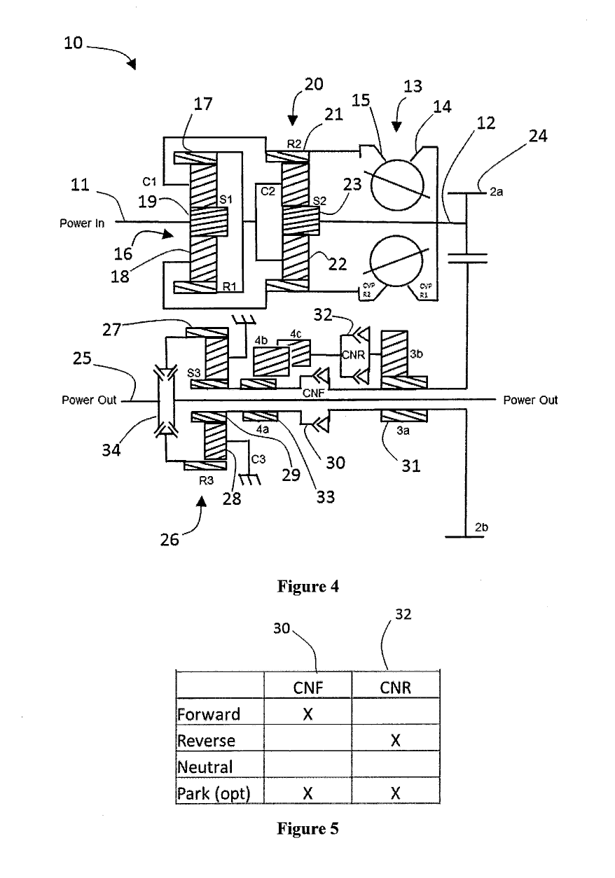

Referring now to FIG. 4, in some embodiments, a continuously variable transmission (CVT) 10 is provided with a first rotatable shaft 11 adapted to receive power from a source of rotational power. In some embodiments, the CVT 10 has a second rotatable shaft 12 coaxial with the first rotatable shaft 11. The first rotatable shaft 11 and the second rotatable shaft 12 form a main axis of the CVT 10. The CVT 10 has a variator assembly 13 arranged coaxial with the main axis. In some embodiments, the variator assembly 13 is configured to be a CVP of the type depicted in FIGS. 1-3. In some embodiments, the variator assembly 13 has a first traction ring assembly (“CVPR1”) 14 and a second traction ring assembly (“CVPR2”) 15 in contact with an array of balls. In some embodiments, the CVT 10 is provided with a first planetary gear set 16 arranged coaxial with the main axis. The first planetary gear set 16 includes a first ring gear (“R1”) 17, a first planet carrier (“C1”) 18, and a first sun gear (“S1”) 19. In some embodiments, the CVT 10 includes a second planetary gear set 20 arranged coaxial with the main axis. The second planetary gear set 20 has a second ring gear (“R2”) 21, a second planet carrier (“C2”) 22, and a second sun gear (“C3”) 23. In some embodiments, the first rotatable shaft 11 is coupled to the first sun gear (“S1”) 19. The first ring gear (“R1”) 17 is coupled to the second planet carrier (“C2”) 22. The first planet carrier (“C1”) 18 is coupled to the second ring gear (“R2”) 21. The second rotatable shaft 12 is coupled to the second sun gear (“S2”) 23 and the first traction ring assembly (“CVPR1”) 14. The second ring gear (“R2”) 21 is coupled to the second traction ring assembly (“CVPR2”) 15. The second rotatable shaft 12 is coupled to a first gear set 24.

Still referring to FIG. 4, in some embodiments, the CVT 10 is provided with a third rotatable shaft 25 aligned parallel to the main axis. The CVT 10 has a third planetary gear set 26 arranged coaxial with the third rotatable shaft 25. The third planetary gear set 26 includes a third ring gear 27, a third planet carrier 28, and a third sun gear 29. The third planet carrier 28 is grounded to a non-rotatable component of the CVT 10 such as the housing (not shown). In some embodiments, the CVT 10 includes a forward clutch 30 arranged coaxial with the third rotatable shaft 25. In some embodiments, the forward clutch 30 is a synchronizer clutch. The forward clutch 30 is coupled to a second gear set 31. The second gear set 31 is coupled to the first gear set 24. In some embodiments, the CVT 10 includes a reverse clutch 32. In some embodiments, the reverse clutch 32 is a synchronizer clutch. The reverse clutch 32 is coupled to a third gear set 33 (labeled in FIG. 4 as “4a”, “4b”, and “4c”). The third gear set 33 is configured to transfer power to the reverse clutch 32 from the third sun gear 29. The CVT 10 includes a final drive gear 34 operably coupled to the third rotatable shaft 25. The third ring gear 27 is operably coupled to the final drive gear 34. In some embodiments, the first gear set 24, the second gear set 31, and the third gear set 33 have two or more meshing gears configured to transfer rotational power. It should be appreciated that in some embodiments, the first gear set 24, the second gear set 31, and the third gear set 33 are optionally configured to be chains driving sprockets, or belts driving pulleys. In some embodiments, the final drive (26) is optionally configured to be a gear set or chain driving another axis. In some embodiments, the third rotatable shaft 25 is configured to be coaxial with the main axis as in the case for rear wheel drive applications.

Typically, synchronizer mechanisms (referred to herein as “synchronizer clutch”) used in power transmissions include a well-known dog clutch integrated with a speed-matching device such as a cone-clutch. During operation of the transmission, if the dog teeth of the dog clutch make contact with a gear, and the two parts are spinning at different speeds, the teeth will fail to engage and a loud grinding sound will be heard as they clatter together. For this reason, a synchronizer mechanism or synchronizer clutch is used, which consists of a cone clutch. Before the teeth engage, the cone clutch engages first, which brings the two rotating elements to the same speed using friction. Until synchronization occurs, the teeth are prevented from making contact. It should be appreciated that the exact design of the synchronizer clutch is within a designer's choice for satisfying packaging and performance requirements. A synchronizer clutch is optionally configured to be a two position clutch having an engaged position and a neutral (or free) position. A synchronizer clutch is optionally configured to be a three position clutch having a first engaged position, a second engaged position, and a neutral position. Embodiments disclosed herein use synchronizer clutches to enable the pre-selection of gear sets by a control system (not shown) for smooth transition between operating modes of the transmission. It should be appreciated that other types of clutches are optionally implemented in place of synchronizer clutch to achieve the transmission configurations disclosed herein.

Referring now to FIG. 5, during operation of the CVT 10, a forward mode of operation corresponds to the selective engagement of the forward synchronizer clutch 30 and the disengagement of the reverse synchronizer clutch 32. A reverse mode of operation corresponds to the selective engagement of the reverse synchronizer clutch 32 and the disengagement of the forward synchronizer clutch 30. A neutral mode of operation corresponds to the disengagement of the forward synchronizer clutch 30 and disengagement of the reverse synchronizer clutch 32. A park mode of operation corresponds to the simultaneous engagement of both the forward synchronizer clutch 30 and the reverse synchronizer clutch 32.

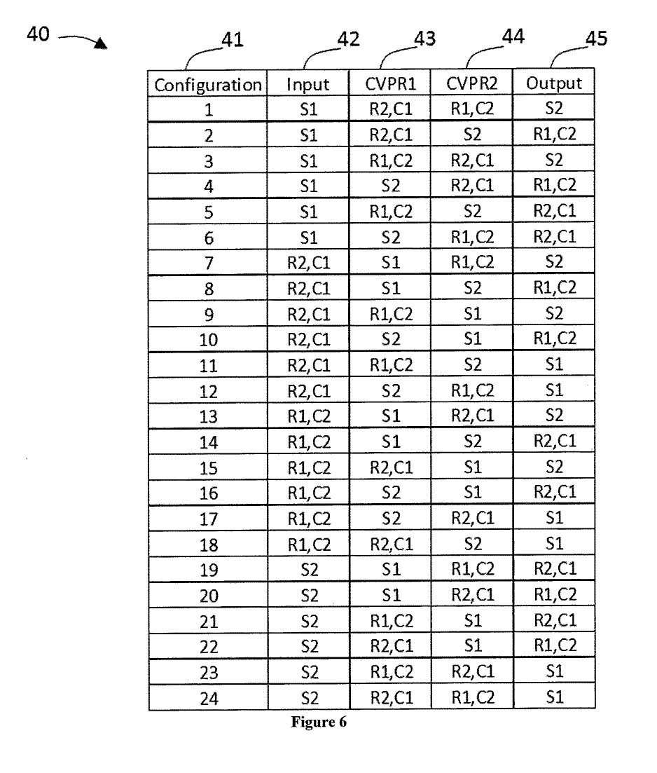

Turning now to FIG. 6, a number of continuously variable transmission architectures are configurable using a variator assembly, such as the variator assembly 13, a first planetary gear set, such as the first planetary gear set 16, and a second planetary gear set, such as the second planetary gear set 20. For clarity and conciseness, the first planetary gear set is depicted as having the following components: a first ring gear (R1), a first planet carrier (C1), and a first sun gear (S1). The second planetary gear set is depicted as having the following components: a second ring gear (R2), a second planet carrier (C2), and a second sun gear (S2). A table 40 depicts a number of continuously variable transmission architectures listed in column 41 labeled “Configuration”. The table 40 has column 42 (“Input”) listing the planetary gear set component, or components, coupling to an input power source. An illustrative example of an input power source is embodied in the first rotatable shaft 11. The table 40 has column 43 (“CVPR1”) listing the planetary gear set component, or components, coupling to the first traction ring assembly of the variator assembly, for example, the first traction ring assembly 14. The table 40 has column 44 (“CVPR2”) listing the planetary gear set component, or components, coupling to the second traction ring assembly of the variator assembly, for example the second traction ring assembly 15. The table 40 has a column 45 (“Output”) listing the planetary component, or components, configured to provide an output power. An illustrative example of an output power coupling is embodied in the second rotatable shaft 12. Each row of the table 40 represents a continuously variable transmission configuration and the connections or couplings of planetary components. For example, the configuration listed as “1” represents a continuously variable transmission configuration having the first sun gear (S1) coupled to an input power source (Input), the second ring gear (R2) and the first planet carrier (C1) coupled to the first traction ring assembly (CVPR1), the first ring gear (R1) and the second planet carrier (C2) coupled to the second traction ring assembly (CVPR2), and the second sun gear (S2) configured to provide a power output (Output). It should be appreciated that the configurations depicted in table 40 are optionally provided with additional gear set, clutches, and shafts to suit desired operating characteristics.

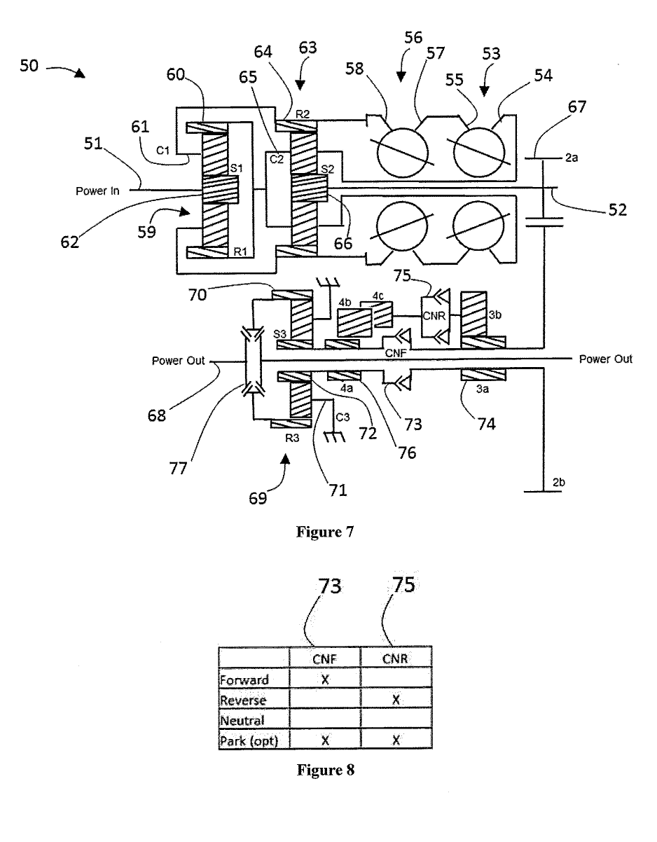

Referring now to FIG. 7, in some embodiments a continuously variable transmission (CVT) 50 is provided with a first rotatable shaft 51 adapted to receive power from a source of rotational power. In some embodiments, the CVT 50 has a second rotatable shaft 52 coaxial with the first rotatable shaft 51. The first rotatable shaft 51 and the second rotatable shaft 52 form a main axis of the CVT 50. The CVT 50 has a first variator assembly 53 arranged coaxial with the main axis. In some embodiments, the first variator assembly 53 is configured to be a CVP of the type depicted in FIGS. 1-3. In some embodiments, the first variator assembly 53 has a first traction ring assembly 54 and a second traction ring assembly 55 in contact with an array of balls. In some embodiments, the CVT 50 is provided with a second variator assembly 56 arranged coaxial with the main axis. The second variator assembly 56 includes a third traction ring assembly 57 and a fourth traction ring assembly 58. In some embodiments, the third traction ring assembly 57 is coupled to the second traction ring assembly 55. In other embodiments, the third traction ring assembly 57 and the second traction ring assembly 55 are an integral component. In some embodiments, the CVT 50 is provided with a first planetary gear set 59 arranged coaxial with the main axis. The first planetary gear set 59 includes a first ring gear (“R1”) 60, a first planet carrier (“C1”) 61 and a first sun gear (“S1”) 62. In some embodiments, the CVT 50 includes a second planetary gear set 63 arranged coaxial with the main axis. The second planetary gear set 63 has a second ring gear (“R2”) 64, a second planet carrier (“C2”) 65, and a second sun gear (“C3”) 66. In some embodiments, the first rotatable shaft 51 is coupled to the first sun gear (“S1”) 62. The first ring gear (“R1”) 60 is coupled to the second planet carrier (“C2”) 65. The first planet carrier (“C1”) 61 is coupled to the second ring gear (“R2”) 64. The second rotatable shaft 52 is coupled to the second sun gear (“S2”) 66 The second planet carrier (“C2”) 65 is coupled to the first traction ring assembly 54. The second ring gear (“R2”) 64 is coupled to the fourth traction ring assembly 58. The second rotatable shaft 52 is coupled to a first gear set 67.

Still referring to FIG. 7, in some embodiments, the CVT 50 is provided with a third rotatable shaft 68 aligned parallel to the main axis. The CVT 50 has a third planetary gear set 69 arranged coaxial with the third rotatable shaft 68. The third planetary gear set 69 includes a third ring gear 70, a third planet carrier 71, and a third sun gear 72. The third planet carrier 71 is grounded to a non-rotatable component of the CVT 50 such as the housing (not shown). In some embodiments, the CVT 50 includes a forward clutch 73 arranged coaxial with the third rotatable shaft 68. In some embodiments, the forward clutch 73 is a synchronizer clutch. The forward clutch 73 is coupled to a second gear set 74. The second gear set 74 is coupled to the first gear set 67. In some embodiments, the CVT 50 includes a reverse clutch 75. In some embodiments, the reverse clutch 75 is a synchronizer clutch. The reverse clutch 75 is coupled to a third gear set 76 (labeled in FIG. 7 as “4a”, “4b”, and “4c”). The third gear set 76 is configured to transfer power to the reverse clutch 75 from the third sun gear 72. The CVT 50 includes a final drive gear 77 operably coupled to the third rotatable shaft 68. The third ring gear 70 is operably coupled to the final drive gear 77. In some embodiments, the first gear set 67, the second gear set 74, and the third gear set 76 have two or more meshing gears configured to transfer rotational power. It should be appreciated that in some embodiments, the first gear set 67, the second gear set 74, and the third gear set 76 are optionally configured to be chains driving sprockets, or belts driving pulleys. In some embodiments, the final drive 77 is optionally configured to be a gear set or chain driving another axis.

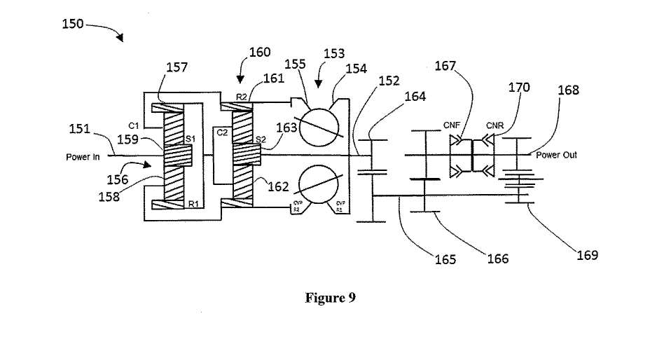

Referring now to FIG. 8, during operation of the CVT 50, a forward mode of operation corresponds to the selective engagement of the forward synchronizer clutch 73 and the disengagement of the reverse synchronizer clutch 75. A reverse mode of operation corresponds to the selective engagement of the reverse synchronizer clutch 75 and the disengagement of the forward synchronizer clutch 73. A neutral mode of operation corresponds to the disengagement of the forward synchronizer clutch 73 and disengagement of the reverse synchronizer clutch 75. A park mode of operation corresponds to the simultaneous engagement of both the forward synchronizer clutch 73 and the reverse synchronizer clutch 75.

Referring now to FIG. 9, in some embodiments, a continuously variable transmission (CVT) 150 is provided with a first rotatable shaft 151 adapted to receive power from a source of rotational power. In some embodiments, the CVT 150 has a second rotatable shaft 152 coaxial with the first rotatable shaft 151. The first rotatable shaft 151 and the second rotatable shaft 152 form a main axis of the CVT 150. The CVT 150 has a variator assembly 153 arranged coaxial with the main axis. In some embodiments, the variator assembly 153 is configured to be a CVP of the type depicted in FIGS. 1-3. In some embodiments, the variator assembly 153 has a first traction ring assembly (“CVPR1”) 154 and a second traction ring assembly (“CVPR2”) 155 in contact with an array of balls. In some embodiments, the CVT 150 is provided with a first planetary gear set 156 arranged coaxial with the main axis. The first planetary gear set 156 includes a first ring gear (“R1”) 157, a first planet carrier (“C1”) 158, and a first sun gear (“S1”) 159. In some embodiments, the CVT 150 includes a second planetary gear set 160 arranged coaxial with the main axis. The second planetary gear set 160 has a second ring gear (“R2”) 161, a second planet carrier (“C2”) 162, and a second sun gear (“C3”) 163. In some embodiments, the first rotatable shaft 151 is coupled to the first sun gear (“S1”) 159. The first ring gear (“R1”) 157 is coupled to the second planet carrier (“C2”) 162. The first planet carrier (“C1”) 158 is coupled to the second ring gear (“R2”) 161. The second rotatable shaft 152 is coupled to the second sun gear (“S2”) 163 and the first traction ring assembly (“CVPR1”) 154. The second ring gear (“R2”) 161 is coupled to the second traction ring assembly (“CVPR2”) 155. The second rotatable shaft 152 is coupled to a first gear set 164. The first gear set 164 is coupled to a third rotatable shaft 165. The third rotatable shaft 165 is parallel to the main axis formed by the first rotatable shaft 151 and the second rotatable shaft 152. In some embodiments, the CVT 150 includes a second gear set 166 coupled to the third rotatable shaft 165 and a first synchronizer clutch 167. The first synchronizer clutch 167 is coupled to a fourth rotatable shaft 168. The fourth rotatable shaft 168 is coaxial with the main axis. In some embodiments, the CVT 150 includes a reverse gear set 169 coupled to the third rotatable shaft 165 and a reverse synchronizer clutch 170. The reverse synchronizer clutch 170 is coupled to the fourth rotatable shaft 168. In some embodiments, the first synchronizer clutch 167 and the reverse synchronizer clutch 170 are configured as a three position synchronizer clutch. During operation of the CVT 150, engagement of the first synchronizer clutch 167 corresponds to operation in a forward direction. Engagement of the reverse synchronizer clutch 170 corresponds to operation in a reverse direction.

It should be noted that the description above has provided dimensions for certain components or subassemblies. The mentioned dimensions, or ranges of dimensions, are provided in order to comply as best as possible with certain legal requirements, such as best mode. However, the scope of the preferred embodiments described herein are to be determined solely by the language of the claims, and consequently, none of the mentioned dimensions is to be considered limiting on the inventive embodiments, except in so far as any one claim makes a specified dimension, or range of thereof, a feature of the claim.

While preferred embodiments have been shown and described herein, it will be obvious to those skilled in the art that such embodiments are provided by way of example only. Numerous variations, changes, and substitutions will now occur to those skilled in the art without departing from the preferred embodiments. It should be understood that various alternatives to the embodiments described herein may be employed in practicing the preferred embodiments. It is intended that the following claims define the scope of the preferred embodiments and that methods and structures within the scope of these claims and their equivalents be covered thereby.

What is claimed is:

1. A continuously variable transmission comprising:
a first rotatable shaft operably coupleable to a source of rotational power;
a second rotatable shaft aligned coaxial to the first rotatable shaft, the first rotatable shaft and second rotatable shaft forming a main axis of the transmission;
a third rotatable shaft aligned parallel to the main axis;
a variator assembly having a first traction ring assembly and a second traction ring assembly in contact with a first plurality of balls, each ball having a tiltable axis of rotation;
wherein the variator assembly is coaxial with the main axis, the first traction ring assembly is coupled to the second rotatable shaft;
a first planetary gear set arranged coaxial with the main axis having a first sun gear coupled to the first rotatable shaft, a first planet carrier, and a first ring gear;
a second planetary gear set arranged coaxial with the main axis having a second planet carrier operably coupled to the first ring gear, a second ring gear operably coupled to the first planet carrier, and a second sun gear coupled to the second rotatable shaft;
a third planetary gear set arranged coaxial with the third rotatable shaft, the third planetary gear set having a third sun gear, a third ring gear, and a third planet carrier that is grounded;
a forward clutch operably coupled to the third sun gear and positioned coaxial with the third rotatable shaft; and
a reverse clutch operably coupled to the forward clutch and the third sun gear.

2. The continuously variable transmission of claim 1, further comprising a first gear set coupled to the second rotatable shaft.

3. The continuously variable transmission of claim 2, further comprising a second gear set coupled to the first gear set and the forward clutch.

4. The continuously variable transmission of claim 3, further comprising a third gear set coupled to the third sun gear, the forward clutch, and the reverse clutch.

5. The continuously variable transmission of claim 4, wherein the forward clutch is a synchronizer clutch.

6. The continuously variable transmission of claim 5, wherein the reverse clutch is a synchronizer clutch.

7. The continuously variable transmission of claim 6, further comprising a final drive gear operably coupled to the third ring gear.

8. The continuously variable transmission of claim 1, wherein the variator comprises a traction fluid.

9. The continuously variable transmission of claim 1, wherein the second traction ring assembly is coupled to the second ring gear.

10. The continuously variable transmission of claim 1, further comprising a second variator assembly having a third traction ring assembly and a fourth traction ring assembly in contact with a second plurality of balls, each ball having a tiltable axis of rotation, wherein the third traction ring assembly is coupled to the second traction ring assembly, and wherein the fourth traction ring assembly is coupled to the second ring gear.

11. A vehicle driveline comprising: a power source, a variable transmission of any of claims 1-10 drivingly engaged with the power source, and a vehicle output drivingly engaged with the variable transmission.

12. The vehicle driveline of claim 11, wherein the power source is drivingly engaged with the vehicle output.

13. A vehicle comprising the variable transmission of any one of claims 1-10.

14. A method comprising providing a variable transmission of any one of claims 1-10.

15. A method comprising providing a vehicle driveline of claim 11 or 12.

16. A method comprising providing a vehicle of claim 13.

17. A continuously variable transmission comprising:
a first rotatable shaft operably coupleable to a source of rotational power;
a second rotatable shaft aligned coaxial to the first rotatable shaft, the first rotatable shaft and second rotatable shaft forming a main axis of the transmission;
a variator assembly having a first traction ring assembly and a second traction ring assembly in contact with a first plurality of balls, each ball having a tiltable axis of rotation;
wherein the variator assembly is coaxial with the main axis;
a first planetary gear set arranged coaxial with the main axis having a first sun gear, a first planet carrier, and a first ring gear;
a second planetary gear set arranged coaxial with the main axis having a second sun gear, a second planet carrier, and a second ring gear;
wherein the first planetary gear set is coupled to the second planetary gear set; and
wherein the variator assembly is coupled to the first planetary gear set and the second planetary gear set.

18. The continuously variable transmission of claim 17, wherein the first rotatable shaft is coupled to the first sun gear.

19. The continuously variable transmission of claim 17, wherein the first rotatable shaft is coupled to the second ring gear and the first planet carrier.

20. The continuously variable transmission of claim 17, wherein the first rotatable shaft is coupled to the first ring gear and the second planet carrier.

21. The continuously variable transmission of claim 17, wherein the first rotatable shaft is coupled to the second sun gear.

22. The continuously variable transmission of claim 18, wherein the first traction ring assembly is coupled to the second ring gear and the first planet carrier.

23. The continuously variable transmission of claim 18, wherein the first traction ring assembly is coupled to the first ring gear and the second planet carrier.

24. The continuously variable transmission of claim 18, wherein the first traction ring assembly is coupled to the second sun gear.

25. The continuously variable transmission of claim 19, wherein the first traction ring assembly is coupled to the first sun gear.

26. The continuously variable transmission of claim 19, wherein the first traction ring assembly is coupled to the first ring gear and the second planet carrier.

27. The continuously variable transmission of claim 19, wherein the first traction ring assembly is coupled to the second sun gear.

28. The continuously variable transmission of claim 20, wherein the first traction ring assembly is coupled to the first sun gear.

29. The continuously variable transmission of claim 20, wherein the first traction ring assembly is coupled to the second ring gear and the first planet carrier.

30. The continuously variable transmission of claim 20, wherein the first traction ring assembly is coupled to the second sun gear.

31. The continuously variable transmission of claim 20, wherein the first traction ring assembly is coupled to the first sun gear.

32. The continuously variable transmission of claim 20, wherein the first traction ring assembly is coupled to the first ring gear and the second planet carrier.

33. The continuously variable transmission of claim 21, wherein the first traction ring assembly is coupled to the second ring gear and the first planet carrier.

34. The continuously variable transmission of claim 22, wherein the second traction ring assembly is coupled to the first ring gear and the second planet carrier.

35. The continuously variable transmission of claim 22, wherein the second traction ring assembly is coupled to the second sun gear.

36. The continuously variable transmission of claim 23, wherein the second traction ring assembly is coupled to the second ring gear and the first planet carrier.

37. The continuously variable transmission of claim 23, wherein the second traction ring assembly is coupled to the second sun gear.

38. The continuously variable transmission of claim 24, wherein the second traction ring assembly is coupled to the second ring gear and the first planet carrier.

39. The continuously variable transmission of claim 24, wherein the second traction ring assembly is coupled to the first ring gear and the second planet carrier.

40. The continuously variable transmission of claim 25, wherein the second traction ring assembly is coupled to the first ring gear and the second planet carrier.

41. The continuously variable transmission of claim 25, wherein the second traction ring assembly is coupled to the second sun gear.

42. The continuously variable transmission of claim 26, wherein the second traction ring assembly is coupled to the first sun gear.

43. The continuously variable transmission of claim 26, wherein the second traction ring assembly is coupled to the second sun gear.

44. The continuously variable transmission of claim 27, wherein the second traction ring assembly is coupled to the first sun gear.

45. The continuously variable transmission of claim 27, wherein the second traction ring assembly is coupled to the second ring gear and the first planet carrier.

46. The continuously variable transmission of claim 28, wherein the second traction ring assembly is coupled to the first ring gear and the second planet carrier.

47. The continuously variable transmission of claim 28, wherein the second traction ring assembly is coupled to the second sun gear.

48. The continuously variable transmission of claim 29, wherein the second traction ring assembly is coupled to the first sun gear.

49. The continuously variable transmission of claim 29, wherein the second traction ring assembly is coupled to the second sun gear.

50. The continuously variable transmission of claim 30, wherein the second traction ring assembly is coupled to the first sun gear.

51. The continuously variable transmission of claim 30, wherein the second traction ring assembly is coupled to the second ring gear and the first planet carrier.

52. The continuously variable transmission of claim 31, wherein the second traction ring assembly is coupled to the first ring gear and the second planet carrier.

53. The continuously variable transmission of claim 31, wherein the second traction ring assembly is coupled to the second ring gear and the first planet carrier.

54. The continuously variable transmission of claim 32, wherein the second traction ring assembly is coupled to the first sun gear.

55. The continuously variable transmission of claim 32, wherein the second traction ring assembly is coupled to the second ring gear and the first planet carrier.

56. The continuously variable transmission of claim 33, wherein the second traction ring assembly is coupled to the first sun gear.

57. The continuously variable transmission of claim 33, wherein the second traction ring assembly is coupled to the first ring gear and the second planet carrier.

58. The continuously variable transmission of claim 34, wherein the second rotatable shaft is coupled to the second sun gear.

59. The continuously variable transmission of claim 35, wherein the second rotatable shaft is coupled to the first ring gear and the second planet carrier.

60. The continuously variable transmission of claim 36, wherein the second rotatable shaft is coupled to the second sun gear.

61. The continuously variable transmission of claim 37, wherein the second rotatable shaft is coupled to the second ring gear and the first planet carrier.

62. The continuously variable transmission of claim 38, wherein the second rotatable shaft is coupled to the first ring gear and the second planet carrier.

63. The continuously variable transmission of claim 39, wherein the second rotatable shaft is coupled to the second ring gear and the first planet carrier.

64. The continuously variable transmission of claim 40, wherein the second rotatable shaft is coupled to the second sun gear.

65. The continuously variable transmission of claim 41, wherein the second rotatable shaft is coupled to the first ring gear and the second planet carrier.

66. The continuously variable transmission of claim 42, wherein the second rotatable shaft is coupled to the second sun gear.

67. The continuously variable transmission of claim 43, wherein the second rotatable shaft is coupled to the first sun gear.

68. The continuously variable transmission of claim 44, wherein the second rotatable shaft is coupled to the first ring gear and the second planet carrier.

69. The continuously variable transmission of claim 45, wherein the second rotatable shaft is coupled to the first sun gear.

70. The continuously variable transmission of claim 46, wherein the second rotatable shaft is coupled to the second sun gear.

71. The continuously variable transmission of claim 47, wherein the second rotatable shaft is coupled to the second ring gear and the first planet carrier.

72. The continuously variable transmission of claim 48, wherein the second rotatable shaft is coupled to the second sun gear.

73. The continuously variable transmission of claim 49, wherein the second rotatable shaft is coupled to the first sun gear.

74. The continuously variable transmission of claim 50, wherein the second rotatable shaft is coupled to the second ring gear and the first planet carrier.

75. The continuously variable transmission of claim 51, wherein the second rotatable shaft is coupled to the first sun gear.

76. The continuously variable transmission of claim 52, wherein the second rotatable shaft is coupled to the second ring gear and the first planet carrier.

77. The continuously variable transmission of claim 53, wherein the second rotatable shaft is coupled to the first ring gear and the second planet carrier.

78. The continuously variable transmission of claim 54, wherein the second rotatable shaft is coupled to the second ring gear and the first planet carrier.

79. The continuously variable transmission of claim 55, wherein the second rotatable shaft is coupled to the first sun gear.

80. The continuously variable transmission of claim 56, wherein the second rotatable shaft is coupled to the first ring gear and the second planet carrier.

81. The continuously variable transmission of claim 57, wherein the second rotatable shaft is coupled to the first sun gear.

82. The continuously variable transmission of claim 10, wherein the third traction ring assembly and the second traction ring assembly are an integral component.
